(19) United States
(12) Patent Application Publication
(10) Pub. No.: US 2025/0344245 A1
(43) Pub. Date: Nov. 6, 2025

(54) CONTENTION WINDOW SIZE FOR UNLICENSED OPERATION

(71) Applicant: Lenovo (Singapore) Pte. Limited, Singapore (SG)

(72) Inventors: Karthikeyan Ganesan, Kronberg Im Taunus (DE); Alexander Golitschek Edler von Elbwart, Darmstadt (DE); Joachim Löhr, Wiesbaden (DE); Prateek Basu Mallick, Dreieich (DE); Ravi Kuchibhotla, Chicago, IL (US)

(73) Assignee: Lenovo (Singapore) Pte. Limited, Singapore (SG)

(21) Appl. No.: 18/860,387

(22) PCT Filed: Apr. 25, 2023
(86) PCT No.: PCT/IB2023/054245

§ 371 Date: Oct. 25, 2024

Related U.S. Application Data
(60) Provisional application No. 63/335,658, filed on Apr. 27, 2022.

(51) Int. Cl. H04W 74/0816; H04W 72/02; H04W 72/40; H04W 74/08; H04W 80/02

(52) U.S. Cl. CPC H04W 74/0816; H04W 72/02; H04W 72/40; H04W 74/0875; H04W 80/02

(57) ABSTRACT

Various aspects of the present disclosure relate to a UE that obtains a configuration of a candidate resource selection in an unlicensed operation, such as for a sidelink communication. The UE establishes a minimum time offset value for a contention window size (CWS), and can report the minimum time offset value for the CWS, such as to a candidate resource selection procedure for autonomous resource selection by the apparatus, or to a base station (e.g., gNB).

### RELATED APPLICATION

This application claims priority to U.S. Provisional Application Ser. No. 63/335,658 filed Apr. 27, 2022 entitled “Contention Window Size for Unlicensed Operation,” the disclosure of which is incorporated by reference herein in its entirety.

### TECHNICAL FIELD

The present disclosure relates to wireless communications, and more specifically to contention window size (CWS) for unlicensed operation.

### BACKGROUND

A wireless communications system may include one or multiple network communication devices, such as base stations, which may be otherwise known as an eNodeB (eNB), a next-generation NodeB (gNB), core network functions (CNFs), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system, such as time resources (e.g., symbols, slots, subslots, mini-slots, aggregated slots, subframes, frames, or the like) or frequency resources (e.g., subcarriers, carriers). Additionally, the wireless communications system may support wireless communications across various radio access technologies (RATs) including third generation (3G) RAT, fourth generation (4G) RAT, fifth generation (5G) RAT, and other suitable RATs beyond 5G. In some cases, a wireless communications system may be a non-terrestrial network (NTN), which may support various communication devices for wireless communications in the NTN. For example, an NTN may include network entities onboard non-terrestrial vehicles such as satellites, unmanned aerial vehicles (UAV), and high-altitude platforms systems (HAPS), as well as network entities on the ground, such as gateway entities capable of transmitting and receiving over long distances.

For sidelink communications as an unlicensed operation in a wireless communications system, the CWS is based on a channel access priority class (CAPC) and used to prevent frame collisions by device communications on a channel. Before frame transmissions, a device selects a random timer value within the contention window range and counts down a timer until the timer expires, at which time a transmission is allowed on a medium that is idle. In the absence of an acknowledgement (ACK), a transmitting device can increase (e.g., double) the contention window size to reduce the probability of subsequent frame collisions, up to a fixed maximum contention window size. However, the contention window size (and update) is internal to a communication device (e.g., a UE), and is not known to the network (e.g., a base station) for providing a mode 1 sidelink grant, or as an input to a mode 2 UE to select the candidate resources accordingly.

### SUMMARY

The present disclosure relates to methods, apparatuses, and systems that support CWS for unlicensed operation. By utilizing the described techniques, a UE can obtain a configuration of a candidate resource selection in an unlicensed operation, and can establish a minimum time offset value for a CWS. The UE can then report the minimum time offset value for the CWS, such as to a candidate resource selection procedure for autonomous resource selection by the UE, to a physical layer (PHY) of the UE for autonomous resource selection by the UE, and/or as a CWS report to a base station (e.g., a gNB). Further, the base station can receive the minimum time offset value for the CWS from the UE, and transmit a signaling indicating a sidelink resource to the UE according to the CWS.

Aspects of the disclosure are directed to a mode 2 candidate resource selection procedure considering CWS and listen-before-talk (LBT). An input parameter, such as a CAPC (e.g., the priority value, maximum channel occupancy time (MCOT), or contention window size) can be selected so that candidate resources are selected according to the next contention window size (i.e., in terms of milli-sec or number of slots/symbols). Further, aspects of the disclosure are directed to a mode 1 candidate resource selection procedure considering CWS and LBT. The UE can transmit in the medium access control (MAC) control element (CE) the updated CWS value or a minimum time offset value, and the base station may provide resources according to the updated CWS value or minimum time offset value.

Some implementations of the method and apparatuses described herein may include wireless communication at a device (e.g., a UE), and the device obtains a configuration of a candidate resource selection in an unlicensed operation, and establishes a minimum time offset value for a CWS. The device also reports the minimum time offset value for the CWS, such as to a candidate resource selection procedure for autonomous resource selection by the device, to a PHY of the device for autonomous resource selection by the device, and/or to a base station (e.g., a gNB).

In some implementations of the method and apparatuses described herein, the configuration of the candidate resource selection includes at least one of a CAPC value, a maximum channel occupancy, a CWS update, or the minimum time offset value. The device (e.g., a LE) establishes the minimum time offset value for the CWS based on an estimate of time to determine sidelink slots by a clear channel assessment procedure. The device transmits a request for a sidelink resource to the base station according to the CWS. The device transmits a MAC CE with the minimum time offset value indicating a completion delay of a clear channel assessment procedure based on time slots requesting a sidelink grant from the base station. The device reselects a sidelink resource based on a completion delay of a clear channel assessment procedure. The completion delay of the clear channel assessment procedure is based on a lack of the candidate resource selection, or is based on a LBT failure. The device performs resource reselection based on a lack of the candidate resource selection being utilized for sidelink transmission due to at least one of a LBT failure or a completion delay of a clear channel assessment procedure.

Some implementations of the method and apparatuses described herein may include wireless communication at a device (e.g., a base station), and the device receives a minimum time offset value for a CWS from a LE, and transmits a signaling indicating a sidelink resource to the LE according to the CWS. In some implementations of the method and apparatuses described herein, the device receives a MAC CE with the minimum time offset value for the CWS from the LE, and transmits the signaling indicating the sidelink resource to the LE based on the MAC CE. The device transmits an additional signaling indicating a deferral time duration associated with a sidelink resource grant. The device transmits the signaling indicating the sidelink resource to the UE based on a highest CWS value corresponding to a channel access priority class.

### BRIEF DESCRIPTION OF THE DRAWINGS

Various aspects of the present disclosure for CWS for unlicensed operation are described with reference to the following Figures. The same numbers may be used throughout to reference like features and components shown in the Figures.

FIG. 1 illustrates an example of a wireless communications system that supports CWS for unlicensed operation in accordance with aspects of the present disclosure.

FIG. 2 illustrates an example of subframes scheduled for sidelink transmission and the LBT components, as related to CWS for unlicensed operation in accordance with aspects of the present disclosure

FIG. 3 illustrates an example block diagram of components of a device (e.g., a UE) that supports CWS for unlicensed operation in accordance with aspects of the present disclosure.

FIG. 4 illustrates an example block diagram of components of a device (e.g., a base station) that supports CWS for unlicensed operation in accordance with aspects of the present disclosure.

FIGS. 5-8 illustrate flowcharts of methods that support CWS for unlicensed operation in accordance with aspects of the present disclosure.

### DETAILED DESCRIPTION

Implementations of CWS for unlicensed operation are described, such as related to sidelink CWS reporting and procedures for unlicensed operation. By utilizing the described techniques, a UE can obtain a configuration of a candidate resource selection in an unlicensed operation, and can establish a minimum time offset value for a CWS. The UE can then report the minimum time offset value for the CWS, such as to a candidate resource selection procedure for autonomous resource selection by the UE, to a PHY of the UE for autonomous resource selection by the UE, and/or as a CWS report to a base station (e.g., a gNB). Further, the base station can receive the minimum time offset value for the CWS from the UE, and transmit a signaling indicating a sidelink resource to the UE according to the CWS.

For sidelink communications as an unlicensed operation in a wireless communications system, the CWS is based on a CAPC and used to prevent frame collisions by device communications on a channel. Before frame transmissions, a device selects a random timer value within the contention window range and counts down a timer until the timer expires, at which time a transmission is allowed on a medium that is idle. In the absence of an ACK, a transmitting device can increase (e.g., double) the contention window size to reduce the probability of subsequent frame collisions, up to a fixed maximum contention window size. However, the contention window size (and update) is internal to a communication device (e.g., a UE), and is not known to the network (e.g., a base station) for providing a mode 1 sidelink grant, or as an input to a mode 2 UE to select the candidate resources accordingly.

Aspects of the disclosure are directed to a mode 2 candidate resource selection procedure considering CWS and LBT. An input parameter, such as a CAPC (e.g., the priority value, MCOT, or contention window size) can be selected so that candidate resources are selected according to the next contention window size (i.e., in terms of milli-sec or number of slots/symbols). Further, aspects of the disclosure are directed to a mode 1 candidate resource selection procedure considering CWS and LBT. The UE can transmit in the MAC CE the updated CWS value or a minimum time offset value, and the base station may provide resources according to the updated CWS value or minimum time offset value.

Aspects of the present disclosure are described in the context of a wireless communications system. Aspects of the present disclosure are further illustrated and described with reference to device diagrams and flowcharts that relate to CWS for unlicensed operation.

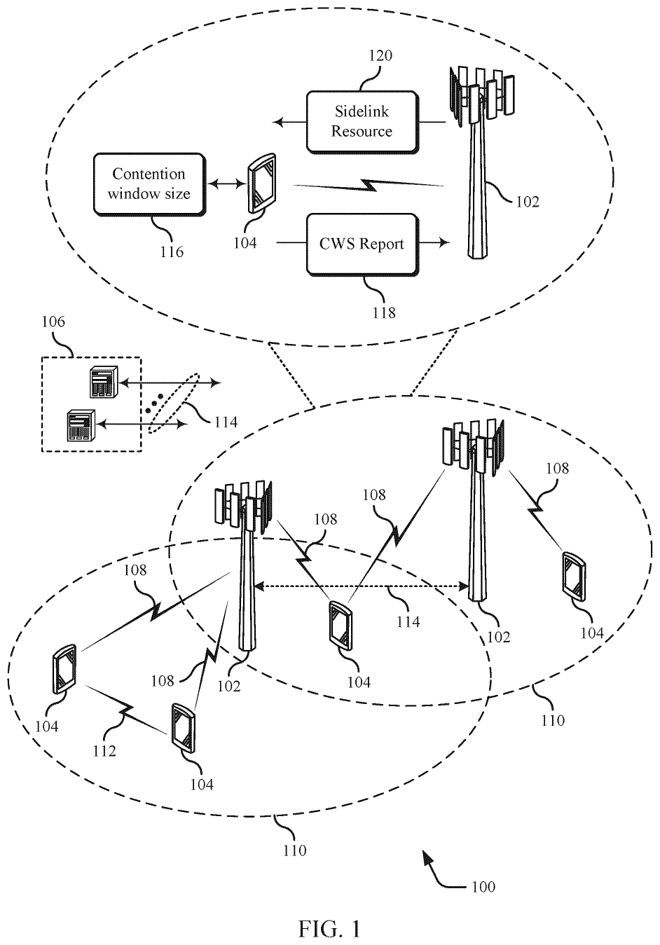

FIG. 1 illustrates an example of a wireless communications system 100 that supports CWS for unlicensed operation in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be, or include, or may be referred to as a base transceiver station, an access point, a NodeB, an eNodeB (eNB), a next-generation NodeB (gNB), a Radio Head (RH), a relay node, an integrated access and backhaul (IAB) node, or other suitable terminology. A base station 102 and a UE 104 may communicate via a communication link 108, which may be a wireless or wired connection. For example, a base station 102 and a UE 104 may perform wireless communication over a NR-Uu interface.

A base station 102 may provide a geographic coverage area 110 for which the base station 102 may support services (e.g., voice, video, packet data, messaging, broadcast, etc.) for one or more UEs 104 within the geographic coverage area. For example, a base station 102 and a UE 104 may support wireless communication of signals related to services (e.g., voice, video, packet data, messaging, broadcast, etc.) according to one or multiple radio access technologies. In some implementations, a base station 102 may be moveable, such as when implemented as a gNB onboard a satellite or other non-terrestrial station (NTS) associated with a non-terrestrial network (NTN). In some implementations, different geographic coverage areas 110 associated with the same or different radio access technologies may overlap, and different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region or coverage area 110 of the wireless communications system 100. A UE 104 may include or may be referred to as a mobile device, a wireless device, a remote device, a handheld device, a customer premise equipment (CPE), a subscriber device, or as some other suitable terminology. In some implementations, the UE 104 may be referred to as a unit, a station, a terminal, or a client, among other examples. Additionally, or alternatively, a UE 104 may be referred to as an Internet-of-Things (IoT) device, an Internet-of-Everything (IoE) device, or as a machine-type communication (MTC) device, among other examples. In some implementations, a UE 104 may be stationary in the wireless communications system 100. In other implementations, a UE 104 may be mobile in the wireless communications system 100, such as an earth station in motion (ESIM).

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, a gateway device, an integrated access and backhaul (IAB) node, a location server that implements the location management function (LMF), or other network equipment). Additionally, or alternatively, a UE 104 may support communication with other base stations 102 or UEs 104, which may act as relays in the wireless communications system 100.

A UE 104 may also support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, or other network interface). The base stations 102 may communicate with each other over the backhaul links (e.g., via an X2, Xn, or another network interface). In some implementations, the base stations 102 may communicate with each other directly (e.g., between the base stations 102). In some other implementations, the base stations 102 may communicate with each other indirectly (e.g., via the core network 106). In some implementations, one or more base stations 102 may include subcomponents, such as an access network entity, which may be an example of an access node controller (ANC). The ANC may communicate with the one or more UEs 104 through one or more other access network transmission entities, which may be referred to as remote radio heads, smart radio heads, gateways, transmission-reception points (TRPs), and other network nodes and/or entities.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)), and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

According to implementations, one or more of the UEs 104 and base stations 102 are operable to implement various aspects of CWS for unlicensed operation, as described herein. For instance, A UE 104 obtains a configuration of a candidate resource selection in an unlicensed operation, and can establish a minimum time offset value for a CWS 116. The UE 104 reports the minimum time offset value for the CWS 116, such as to a candidate resource selection procedure for autonomous resource selection by the UE, to a PHY of the UE for autonomous resource selection by the UE, and/or as a CWS report 118 to a base station 102 (e.g., a gNB). Further, the base station 102 can receive the minimum time offset value for the CWS from the UE 104, and transmit a signaling indicating a sidelink resource 120 to the UE 104 according to the CWS. In implementations, the base station 102 can transmit an indication of the sidelink resource 120 to the UE 104 based on the MAC CE. The base station 102 can also transmit a signaling indicating a deferral time duration associated with the sidelink resource grant. The base station 102 may also transmit signaling indicating the sidelink resource 120 to the UE 104 based on a highest CWS value corresponding to a channel access priority class.

In aspects of CWS for unlicensed operation, the contention window size determined or established by a UE may be function of the channel access priority class, as shown in Table T1.

TABLE T1
Channel Access Priority Class (CAPC)

| Channel | | | | | |
|---|---|---|---|---|---|
| Access | | | | | |
| Priority | | | | | allowed |
| Class (p) | mₚ | CW_{min, p} | CW_{max, p} | T_{mcot, p} | CWₚsizes |
| 1 | 1 | 3 | 7 | 2 ms | {3, 7} |
| 2 | 1 | 7 | 15 | 3 ms | {7, 15} |
| 3 | 3 | 15 | 63 | 8 or | {15, 31, 63} |
| | | | | 10 ms | |
| 4 | 7 | 15 | 1023 | 8 or | {15, 31, 63, 127, |
| | | | | 10 ms | 255, 511, 1023} |

With reference to the Type 1 uplink (UL) channel access procedure, the following describes channel access procedures by a UE where the time duration spanned by the sensing slots that are sensed to be idle before UL transmission(s) is random. This is applicable to the following transmissions: physical uplink shared channel/sounding reference signal (PUSCH/SRS) transmission(s) scheduled or configured by eNB/gNB; or physical uplink control channel (PUCCH) transmission(s) scheduled or configured by gNB; or transmission(s) related to a random access procedure.

A UE may transmit a transmission using the Type 1 channel access procedure after first sensing the channel to be idle during the slot durations of a defer duration T_{d}, and after the counter N is zero (in step 4 below). The counter N is adjusted by sensing the channel for additional slot duration(s) according to the steps described below:
1) set N=Nᵢₙᵢₜ, where Nᵢₙᵢₜ is a random number uniformly distributed between 0 and CWₚ, and go to step 4;
2) if N>0 and the UE chooses to decrement the counter, set N=N−1;
3) sense the channel for an additional slot duration, and if the additional slot duration is idle, go to step 4; else, go to step 5;
4) if N=0, stop; else, go to step 2;
5) sense the channel until either a busy slot is detected within an additional defer duration T_{d} or all the slots of the additional defer duration T_{d} are detected to be idle; and
6) if the channel is sensed to be idle during all the slot durations of the additional defer duration T_{d}, go to step 4; else, go to step 5.

If a UE has not transmitted a UL transmission on a channel on which UL transmission(s) are performed after step 4 in the procedure above, the UE may transmit a transmission on the channel, based on the channel is sensed to be idle at least in a sensing slot duration Tₛₗ when the UE is ready to transmit the transmission, and if the channel has been sensed to be idle during all the slot durations of a defer duration T_{d} immediately before the transmission. If the channel has not been sensed to be idle in a sensing slot duration Tₛₗ when the UE first senses the channel after it is ready to transmit, or if the channel has not been sensed to be idle during any of the sensing slot durations of a defer duration T_{d} immediately before the intended transmission, the UE proceeds to step 1 after sensing the channel to be idle during the slot durations of a defer duration T_{d}.

The defer duration T_{d} consists of duration T_{f}=16 us immediately followed by my consecutive slot durations where each slot duration is Tₛₗ=9 us, and T_{f} includes an idle slot duration Tₛₗ at the start of T_{f}. CW_{min,p}≤CWₚ≤CW_{max,p} is the contention window, with CWₚ adjustment. CW_{min,p} and CW_{max,p} are chosen before step 1 of the procedure above. The mₚ, CW_{min,p}, and CW_{max,p} are based on a channel access priority class p, which is signaled to the UE.

This disclosure takes into account contention window adjustment procedures for UL transmissions scheduled and/or configured by a gNB. If a UE transmits transmissions using Type 1 channel access procedures that are associated with channel access priority class p on a channel, the UE maintains the contention window value CWₚ and adjusts CWₚ for those transmissions before step 1 of the procedure described above, using the following steps:
1) For every priority class p∈{1,2,3,4}, set CWₚ=CW_{min,p};
2) If hybrid automatic repeat request acknowledgement (HARQ-ACK) feedback is available after the last update of CWₚ, go to step 3. Otherwise, if the UE transmission after procedure does not include a retransmission, or is transmitted within a duration T_{w} from the end of the reference duration corresponding to the earliest UL channel occupancy after the last update of CWₚ, go to step 5; otherwise go to step 4;
3) The HARQ-ACK feedback(s) corresponding to PUSCH(s) in the reference duration for the latest UL channel occupancy for which HARQ-ACK feedback is available is used based on: If at least one HARQ-ACK feedback is ‘ACK’ for PUSCH(s) with transport block (TB)-based feedback, or at least 10% of HARQ-ACK feedbacks are ‘ACK’ for PUSCH code block group (CBGs) transmitted at least partially on the channel with CBG based feedback, go to step 1; otherwise go to step 4;
4) Increase CWₚ, for every priority class p∈{1,2,3,4} to the next higher allowed value; and
5) For every priority class p∈{1,2,3,4}, maintain CWₚ as it is; go to step 2.

The HARQ-ACK feedback, reference duration and duration T_{w} in the procedure above are defined as described following. For the purpose of contention window adjustment, HARQ-ACK feedback for PUSCH(s) transmissions is expected to be provided to UE(s) explicitly or implicitly, where explicit HARQ-ACK is determined based on the valid HARQ-ACK feedback in a corresponding configured grant downlink feed information (CG-DFI), and implicit HARQ-ACK feedback is determined based on the indication for a new transmission or retransmission in the downlink control information (DCI) scheduling PUSCH(s) as follows: If a new transmission is indicated, ACK is assumed for the transport blocks or code block groups in the corresponding PUSCH(s) for the TB-based and CBG-based transmission, respectively. If a retransmission is indicated for TB-based transmissions, non-acknowledgement (NACK) is assumed for the transport blocks in the corresponding PUSCH(s). If a retransmission is indicated for CBG-based transmissions, and if a bit value in the code block group transmission information (CBGTI) field is ‘0’ or ‘1’, then ACK or NACK is assumed for the corresponding CBG in the corresponding PUSCH(s), respectively.

The reference duration corresponding to a channel occupancy initiated by the UE including transmission of PUSCH(s) is defined as a duration starting from the beginning of the channel occupancy until the end of the first slot where at least one PUSCH is transmitted over all the resources allocated for the PUSCH, or until the end of the first transmission burst by the UE that contains PUSCH(s) transmitted over all the resources allocated for the PUSCH, whichever occurs earlier. If the channel occupancy includes a PUSCH, but it does not include any PUSCH transmitted over all the resources allocated for that PUSCH, then, the duration of the first transmission burst by the UE within the channel occupancy that contains PUSCH(s) is the reference duration for CWS adjustment. The T_{w}=max (T_{A}, T_{B}+1 ms) where T_{B} is the duration of the transmission burst from start of the reference duration in ms and T_{A}=5 ms if the absence of any other technology sharing the channel cannot be guaranteed on a long-term basis (e.g. by level of regulation), and T_{A}=10 ms otherwise.

If a UE transmits transmissions using Type 1 channel access procedures associated with the channel access priority class p on a channel, and the transmissions are not associated with explicit or implicit HARQ-ACK feedbacks as described above, then the UE adjusts CWₚ before step 1 in the procedures described above, using the latest CWₚ used for any UL transmissions on the channel using Type 1 channel access procedures associated with the channel access priority class p. If the corresponding channel access priority class p has not been used for any UL transmission on the channel, CWₚ=CW_{min,p} is used.

In aspects of this disclosure for CWS for unlicensed operation, terminology includes the following definitions. A receive (Rx) UE is a UE that receives a channel occupancy time (COT) sharing indicator via a sidelink or a downlink connection. A transmit (Tx) UE is a UE that transmits a COT sharing indicator via a sidelink or an uplink connection. A COT initiator is a device that initiates (or initiated) a channel occupancy (e.g. a Tx UE or a gNB). A COT donor is a device that transmits a COT sharing indicator (e.g. a Tx UE or a gNB). The COT donor may be identical to the COT initiator. A COT recipient is a device that receives a COT sharing indicator (e.g. a Rx UE or a gNB). Further, a COT is characterized by one or more of the following properties: A COT initiator is the node initiating a COT (e.g. following a channel access procedure). A channel access priority class is one or more classes that imply required sensing duration when initiating a COT, or MCOT. The MCOT duration of a channel occupancy is counted or measured from the first transmission after initiation of the COT.

The techniques described in this disclosure take into account mode 2 candidate resource selection procedure considering CWS, LBT, and other features. In an implementation, when a UE performs a clear channel assessment procedure to initiate channel occupancy using mode 2 resource selection methodology, the UE PHY may be provided with an input parameter, such as a CAPC which may be the priority value, MCOT, one of the contention window size values from the plurality of the allowed contention window size values. The candidate resources may be selected accordingly to the input contention window size i.e., in terms of milli-sec or number of slots/symbols. Otherwise if the resources were provided earlier than the input contention window size, then the UE may not transmit while the UE waits until the clear channel assessment processing is completed, which involves sensing on slots indicated according to 5 GHz specification. This includes a deferral time (T_{d}) that is equivalent to 16 μs+mₚ*9 μs and sensing on a number of idle slots, where the number of idle slots may be according to the contention window size value of a chosen random integer value between 0 and CWₚ, and performing any additional sensing slot according to the deferral time (T_{d}) if there are any busy slots in between.

If the resources were provided later, then the UE may be need a sensing on slots provided by deferral time (T_{d}) before transmission, where mₚ is provided in the channel access priority table dependent on the channel access class priority value, and where CWₚ is provided in the channel access priority table as a chosen contention window size dependent on the channel access class priority value.

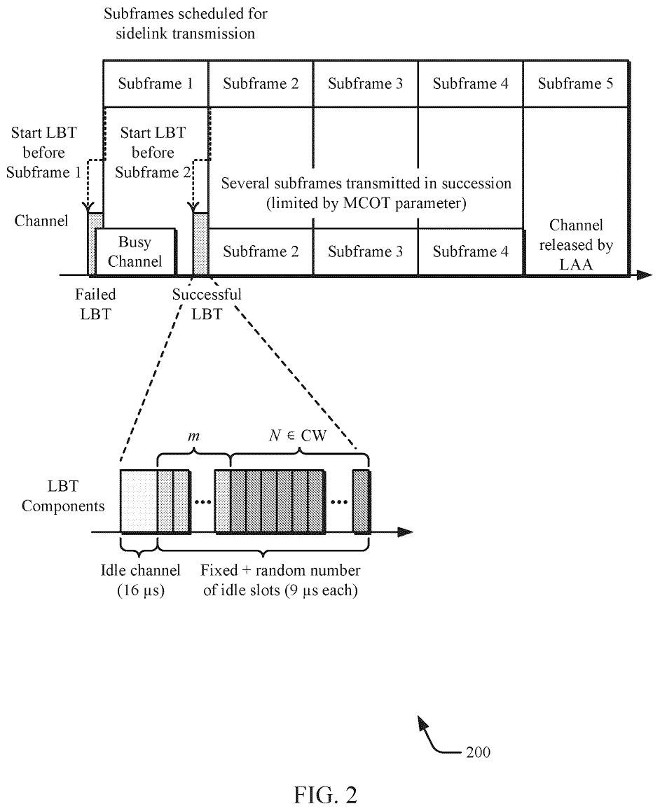

FIG. 2 illustrates an example 200 of subframes scheduled for sidelink transmission and the LBT components, as related to CWS for unlicensed operation in accordance with aspects of the present disclosure. The UE PHY may need a minimum contention window start size in terms of the number of slots/symbols, or in milli-sec, so that the UE can exclude those resources in the candidate resource selection/exclusion procedure. Although FIG. 2 illustrates that the completion time taken for the channel access procedure is within a slot, the completion time may vary according to the subcarrier spacing, which can impact the slot duration. For example, a slot duration of 1 ms is supported with a 14 symbol length for 15 KHz subcarrier spacing, and a slot duration of 0.25 ms is supported for 60 KHz subcarrier spacing, and so on. Generally, the higher the subcarrier spacing, the shorter is the slot duration, and the completion time may span across multiple slots (not illustrated in FIG. 2). Initially, the UE may be provided with the channel access priority value according to the traffic type and/or MCOT duration. The UE may select the candidate resources, such that the UE has enough preparation time to perform sensing for idle slots according to the channel access procedure using deferral time (T_{d}) and sensing on idle slots provided by a random integer value between 0 and the contention window size from the Table T1 CAPC and if any, additional sensing slots according to the deferral time (T_{d}), if there are any busy slots, as shown in the example 200 in the figure.

Since the preparation time taken by the UE for performing sensing according to the clear channel assessment procedure could be random, the UE may choose a random offset value or a value from the (pre-)configured Table T1 CAPC, which can provide the UE with a time offset for candidate resources starting time slot. This value may take into consideration the contention window sizes in the Table T1 for each channel access priority class.

In an implementation, the candidate resources could be reported to the MAC, and the MAC may select the candidate resource for transmission from the candidate resource set according to the random offset value or a value from the (pre-)configured table. The offset may be different according to the subcarrier spacing (SCS), channel access priority value, and contention window size for each channel access priority class. The offset may take into consideration the preparation time which includes deferral time, sensing on idle slots provided by a random integer value between 0 and the contention window size from the Table T1 CAPC, and if any, additional sensing slots according to the deferral time (T_{d}), where the Table T1 can be (pre-)configured in a resource pool.

In another implementation, the (pre-)configured tables have entries containing an offset value, where different tables are needed according to the channel access priority class value and SCS. However the UE may choose the time offset value from the table according to the contention window size update procedure since the number of idle slots for performing may vary according to the contention window size update procedure. The UE can trigger resource (re-)selection if there is any update on the contention window size procedure, for example, when the contention window size value may be increased or decreased. In another implementation, the contention window size value may be compared with a (pre-)configured threshold value (e.g., the threshold may be defined in a number of slots or milli-sec, and could be different according to the SCS, CAPC, etc.), and the UE may perform resource (re-)selection only if the preparation time (e.g., the preparation time defined above) is above this threshold value. The UE can perform resource (re-)evaluation on the (pre-)selected resource or reserved resource if there is any update on the contention window size procedure, for example, when the contention window size value may be increased or decreased.

If the UE selects the candidate resource for transmission when the clear channel assessment procedure could not be finished, then the UE may re-select another resource for transmission from the candidate resources. If the UE does not find any candidate resource, then the UE may trigger resource (re-)selection to find another set of candidate resources. If the clear channel assessment procedure could not be finished before any of the reserved resources, the UE may not perform transmission and then may trigger resource (re-)selection to find more candidate resources. When LBT fails before making a transmission on one or more reserved resources reserved by prior SCI, then the UE may not perform transmission on the reserved resources and may trigger resource (re-)selection to find more candidate resources. If the LBT fails before performing a transmission on (pre-)selected resources, then the UE may (re-)select another resource from the candidate resource set, and if the UE cannot select another resource from the candidate resource set, then the UE may trigger resource (re-)selection.

The techniques described in this disclosure also take into account mode 1 candidate resource selection procedure considering CWS, LBT, and other features. In an implementation, the UE may be informed about the UE's channel access priority class value indirectly by mapping the sidelink resource (SR) configuration to a CAPC value. However, the gNB still may not be aware of the contention window size update procedure performed by the UE for subsequent initiation of channel occupancy. Initially, the gNB may provide a UE with the sidelink resources assuming the first contention window size in the Table T1 according to the CAPC value. Then when the contention window size is updated according to the ACK/NACK procedure and LBT failures, the update CWS value may not be available at the gNB.

The UE may transmit in the MAC CE the updated CWS value or a minimum time offset value, and the gNB may provide resources according to the updated CWS value or minimum time offset value. Since the preparation time taken by the UE for performing sensing according to the clear channel assessment procedure could be random, the UE may not be able to perform a transmission in the indicated sidelink resources. In an implementation, the UE may transmit SR, or an updated value of CWS or a minimum time offset value, to the gNB, which may provide the sidelink resource considering the same base station provides the resource. In another implementation, the UE may transmit an ACK in a PUCCH resource to the gNB, and the gNB may further allocate the sidelink resource for transmission.

In implementations, the SR and/or the buffer status reporting (BSR) transmission from a UE may be delayed considering the preparation time for sensing according to the clear channel assessment procedure, which maybe random when the UE is finishing the clear channel assessment procedure, which maybe ‘x’ idle slots earlier, and the UE may transmit the SR to the gNB so that the gNB may allocate the sidelink resources. In an implementation, the gNB may indicate a deferral time along with the sidelink grant. Further, the gNB may provide the sidelink resource considering the highest contention window size value in the table.

As described above with reference to a mode 2 candidate resource selection procedure considering CWS and LBT, an input parameter, such as a CAPC (e.g., the priority value, MCOT, or contention window size) can be selected so that the candidate resources are selected according to the next contention window size (i.e., in terms of milli-sec or number of slots/symbols). Since the preparation time taken by the UE for performing sensing according to the clear channel assessment procedure could be random, the UE may choose a random offset value or a value from the (pre-)configured table, which may provide the UE with a time offset for candidate resources starting time slot. When the UE selects the candidate resource for transmission while the clear channel assessment procedure could not be completed, then the UE may re-select another resource for transmission from the candidate resources. If the UE did not find a candidate resource, then the UE may trigger resource (re-)selection to find another set of candidate resources. If the clear channel assessment procedure could not be completed before any of the reserved resources, the UE may not perform transmission and the UE may trigger resource (re-)selection to find more candidate resources. If LBT fails before a transmission on a plurality of reserved resources that are reserved by prior sidelink control information (SCI), then the UE may not perform the transmission on the reserved resources and may trigger resource reselection to find more candidate resources.

As described above with reference to a mode 1 candidate resource selection procedure considering CWS and LBT, the UE may transmit in the MAC CE the updated CWS value or a minimum time offset value, and the gNB may provide resources according to the updated CWS value or minimum time offset value. Since the preparation time taken by the UE for performing sensing according to the clear channel assessment procedure could be random, the UE may not be able to perform transmission in the indicated sidelink resources. In an implementation, the UE may transmit SR, an updated value of CWS, or a minimum time offset value to a gNB, and the gNB may provide the sidelink resource considering the same.

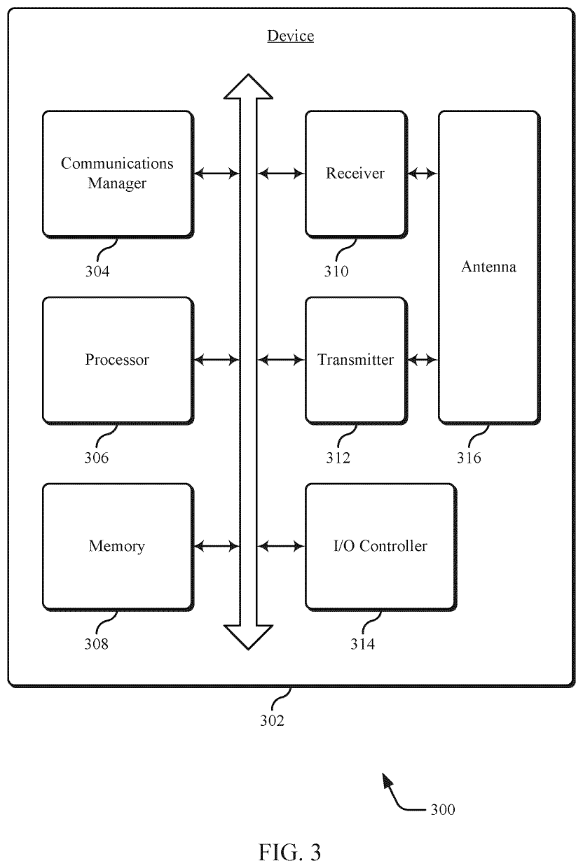

FIG. 3 illustrates an example of a block diagram 300 of a device 302 that supports CWS for unlicensed operation in accordance with aspects of the present disclosure. The device 302 may be an example of a UE 104 as described herein. The device 302 may support wireless communication and/or network signaling with one or more base stations 102, other UEs 104, network entities and devices, or any combination thereof. The device 302 may include components for bi-directional communications including components for transmitting and receiving communications, such as a communications manager 304, a processor 306, a memory 308, a receiver 310, a transmitter 312, and an I/O controller 314. These components may be in electronic communication or otherwise coupled (e.g., operatively, communicatively, functionally, electronically, electrically) via one or more interfaces (e.g., buses).

The communications manager 304, the receiver 310, the transmitter 312, or various combinations thereof or various components thereof may be examples of means for performing various aspects of the present disclosure as described herein. For example, the communications manager 304, the receiver 310, the transmitter 312, or various combinations or components thereof may support a method for performing one or more of the functions described herein.

In some implementations, the communications manager 304, the receiver 310, the transmitter 312, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 306 and the memory 308 coupled with the processor 306 may be configured to perform one or more of the functions described herein (e.g., by executing, by the processor 306, instructions stored in the memory 308).

Additionally or alternatively, in some implementations, the communications manager 304, the receiver 310, the transmitter 312, or various combinations or components thereof may be implemented in code (e.g., as communications management software or firmware) executed by the processor 306. If implemented in code executed by the processor 306, the functions of the communications manager 304, the receiver 310, the transmitter 312, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 304 may be configured to perform various operations (e.g., receiving, monitoring, transmitting) using or otherwise in cooperation with the receiver 310, the transmitter 312, or both. For example, the communications manager 304 may receive information from the receiver 310, send information to the transmitter 312, or be integrated in combination with the receiver 310, the transmitter 312, or both to receive information, transmit information, or perform various other operations as described herein. Although the communications manager 304 is illustrated as a separate component, in some implementations, one or more functions described with reference to the communications manager 304 may be supported by or performed by the processor 306, the memory 308, or any combination thereof. For example, the memory 308 may store code, which may include instructions executable by the processor 306 to cause the device 302 to perform various aspects of the present disclosure as described herein, or the processor 306 and the memory 308 may be otherwise configured to perform or support such operations.

For example, the communications manager 304 may support wireless communication and/or network signaling at a device (e.g., the device 302, a UE) in accordance with examples as disclosed herein. The communications manager 304 and/or other device components may be configured as or otherwise support an apparatus, such as a UE, including a transceiver; a processor coupled to the transceiver, the processor and the transceiver configured to cause the apparatus to: obtain a configuration of a candidate resource selection in an unlicensed operation; establish a minimum time offset value for a CWS; and report the minimum time offset value for the CWS.

Additionally, the apparatus (e.g., a UE) includes any one or combination of: the configuration of the candidate resource selection comprises at least one of a CAPC value, a maximum channel occupancy, a CWS update, or the minimum time offset value. The processor is configured to cause the apparatus to establish the minimum time offset value for the CWS based at least in part on an estimate of time to determine sidelink slots by a clear channel assessment procedure. The processor and the transceiver are configured to cause the apparatus to report the minimum time offset value for the CWS to a candidate resource selection procedure for autonomous resource selection by the apparatus. The processor and the transceiver are configured to cause the apparatus to report the minimum time offset value for the CWS to a PHY of the apparatus for autonomous resource selection by the apparatus. The processor and the transceiver are configured to cause the apparatus to transmit the minimum time offset value for the CWS to a base station. The processor and the transceiver are configured to cause the apparatus to transmit a request for a sidelink resource to the base station according to the CWS. The processor and the transceiver are configured to cause the apparatus to transmit a MAC CE with the minimum time offset value indicating a completion delay of a clear channel assessment procedure based on time slots requesting a sidelink grant from the base station. The processor is configured to cause the apparatus to reselect a sidelink resource based at least in part on a completion delay of a clear channel assessment procedure. The completion delay of the clear channel assessment procedure is based at least in part on a lack of the candidate resource selection. The completion delay of the clear channel assessment procedure is based at least in part on a LBT failure. The processor is configured to cause the apparatus to perform resource reselection based at least in part on a lack of the candidate resource selection being utilized for sidelink transmission due to at least one of a LBT failure or a completion delay of a clear channel assessment procedure.

The communications manager 304 and/or other device components may be configured as or otherwise support a means for wireless communication and/or network signaling at a UE, including obtaining a configuration of a candidate resource selection in an unlicensed operation; establishing a minimum time offset value for a CWS; and reporting the minimum time offset value for the CWS.

Additionally, wireless communication and/or network signaling at the UE includes any one or combination of: the configuration of the candidate resource selection comprises at least one of a CAPC value, a maximum channel occupancy, a CWS update, or the minimum time offset value. The minimum time offset value for the CWS is established based at least in part on an estimate of time to determine sidelink slots by a clear channel assessment procedure. The minimum time offset value for the CWS is reported to a candidate resource selection procedure for autonomous resource selection by the apparatus. The minimum time offset value for the CWS is reported to a PHY of the apparatus for autonomous resource selection by the apparatus. The method further comprising transmitting the minimum time offset value for the CWS to a base station. The method further comprising transmitting a request for a sidelink resource to the base station according to the CWS. The method further comprising transmitting a MAC CE with the minimum time offset value indicating a completion delay of a clear channel assessment procedure based on time slots requesting a sidelink grant from the base station. The method further comprising reselecting a sidelink resource based at least in part on a completion delay of a clear channel assessment procedure. The completion delay of the clear channel assessment procedure is based at least in part on a lack of the candidate resource selection. The completion delay of the clear channel assessment procedure is based at least in part on a LBT failure. The method further comprising performing resource reselection based at least in part on a lack of the candidate resource selection being utilized for sidelink transmission due to at least one of a LBT failure or a completion delay of a clear channel assessment procedure.

The processor 306 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 306 may be configured to operate a memory array using a memory controller. In some other implementations, a memory controller may be integrated into the processor 306. The processor 306 may be configured to execute computer-readable instructions stored in a memory (e.g., the memory 308) to cause the device 302 to perform various functions of the present disclosure.

The memory 308 may include random access memory (RAM) and read-only memory (ROM). The memory 308 may store computer-readable, computer-executable code including instructions that, when executed by the processor 306 cause the device 302 to perform various functions described herein. The code may be stored in a non-transitory computer-readable medium such as system memory or another type of memory. In some implementations, the code may not be directly executable by the processor 306 but may cause a computer (e.g., when compiled and executed) to perform functions described herein. In some implementations, the memory 308 may include, among other things, a basic I/O system (BIOS) which may control basic hardware or software operation such as the interaction with peripheral components or devices.

The I/O controller 314 may manage input and output signals for the device 302. The I/O controller 314 may also manage peripherals not integrated into the device 302. In some implementations, the I/O controller 314 may represent a physical connection or port to an external peripheral. In some implementations, the I/O controller 314 may utilize an operating system such as iOS®, ANDROID®, MS-DOS®, MS-WINDOWS®, OS/2®, UNIX®, LINUX®, or another known operating system. In some implementations, the I/O controller 314 may be implemented as part of a processor, such as the processor 306. In some implementations, a user may interact with the device 302 via the I/O controller 314 or via hardware components controlled by the I/O controller 314.

In some implementations, the device 302 may include a single antenna 316. However, in some other implementations, the device 302 may have more than one antenna 316, which may be capable of concurrently transmitting or receiving multiple wireless transmissions. The receiver 310 and the transmitter 312 may communicate bi-directionally, via the one or more antennas 316, wired, or wireless links as described herein. For example, the receiver 310 and the transmitter 312 may represent a wireless transceiver and may communicate bi-directionally with another wireless transceiver. The transceiver may also include a modem to modulate the packets, to provide the modulated packets to one or more antennas 316 for transmission, and to demodulate packets received from the one or more antennas 316.

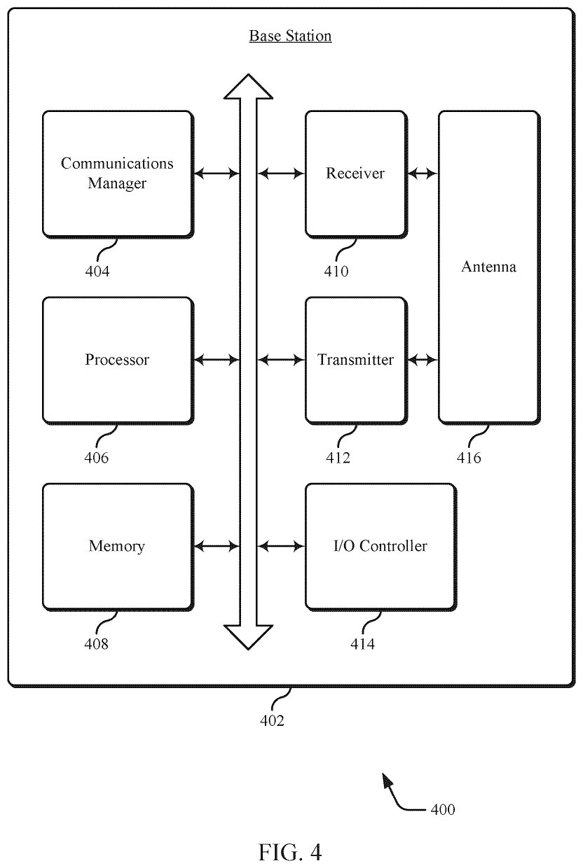

FIG. 4 illustrates an example of a block diagram 400 of a device 402 that supports CWS for unlicensed operation in accordance with aspects of the present disclosure. The device 402 may be an example of a base station 102 (e.g., a gNB) as described herein. The device 402 may support wireless communication and/or network signaling with one or more base stations 102, other UEs 104, core network devices and functions (e.g., core network 106), or any combination thereof. The device 402 may include components for bi-directional communications including components for transmitting and receiving communications, such as a communications manager 404, a processor 406, a memory 408, a receiver 410, a transmitter 412, and an I/O controller 414. These components may be in electronic communication or otherwise coupled (e.g., operatively, communicatively, functionally, electronically, electrically) via one or more interfaces (e.g., buses).

The communications manager 404, the receiver 410, the transmitter 412, or various combinations thereof or various components thereof may be examples of means for performing various aspects of the present disclosure as described herein. For example, the communications manager 404, the receiver 410, the transmitter 412, or various combinations or components thereof may support a method for performing one or more of the functions described herein.

In some implementations, the communications manager 404, the receiver 410, the transmitter 412, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 406 and the memory 408 coupled with the processor 406 may be configured to perform one or more of the functions described herein (e.g., by executing, by the processor 406, instructions stored in the memory 408).

Additionally or alternatively, in some implementations, the communications manager 404, the receiver 410, the transmitter 412, or various combinations or components thereof may be implemented in code (e.g., as communications management software or firmware) executed by the processor 406. If implemented in code executed by the processor 406, the functions of the communications manager 404, the receiver 410, the transmitter 412, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 404 may be configured to perform various operations (e.g., receiving, monitoring, transmitting) using or otherwise in cooperation with the receiver 410, the transmitter 412, or both. For example, the communications manager 404 may receive information from the receiver 410, send information to the transmitter 412, or be integrated in combination with the receiver 410, the transmitter 412, or both to receive information, transmit information, or perform various other operations as described herein. Although the communications manager 404 is illustrated as a separate component, in some implementations, one or more functions described with reference to the communications manager 404 may be supported by or performed by the processor 406, the memory 408, or any combination thereof. For example, the memory 408 may store code, which may include instructions executable by the processor 406 to cause the device 402 to perform various aspects of the present disclosure as described herein, or the processor 406 and the memory 408 may be otherwise configured to perform or support such operations.

For example, the communications manager 404 may support wireless communication and/or network signaling at a device (e.g., the device 402, a base station) in accordance with examples as disclosed herein. The communications manager 404 and/or other device components may be configured as or otherwise support an apparatus, such as a base station (e.g., a gNB), including a transceiver; a processor coupled to the transceiver, the processor and the transceiver configured to cause the apparatus to: receive a minimum time offset value for a CWS from a UE; and transmit a signaling indicating a sidelink resource to the UE according to the CWS.

Additionally, the apparatus (e.g., a base station) includes any one or combination of: the processor and the transceiver are configured to cause the apparatus to: receive a MAC CE with the minimum time offset value for the CWS from the UE; and transmit the signaling indicating the sidelink resource to the UE based at least in part on the MAC CE. The processor and the transceiver are configured to cause the apparatus to transmit an additional signaling indicating a deferral time duration associated with a sidelink resource grant. The processor and the transceiver are configured to cause the apparatus to transmit the signaling indicating the sidelink resource to the UE based at least in part on a highest CWS value corresponding to a channel access priority class.

The communications manager 404 and/or other device components may be configured as or otherwise support a means for wireless communication and/or network signaling at a base station, including receiving a minimum time offset value for a contention window size (CWS) from a user equipment (UE); and transmitting a signaling indicating a sidelink resource to the UE according to the CWS.

Additionally, wireless communication at the base station includes any one or combination of: the method further comprising: receiving a MAC CE with the minimum time offset value for the CWS from the UE; and transmitting the signaling indicating the sidelink resource to the UE based at least in part on the MAC CE. The method further comprising transmitting an additional signaling indicating a deferral time duration associated with a sidelink resource grant. The signaling indicating the sidelink resource is transmitted to the UE based at least in part on a highest CWS value corresponding to a channel access priority class.

The processor 406 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 406 may be configured to operate a memory array using a memory controller. In some other implementations, a memory controller may be integrated into the processor 406. The processor 406 may be configured to execute computer-readable instructions stored in a memory (e.g., the memory 408) to cause the device 402 to perform various functions of the present disclosure.

The memory 408 may include random access memory (RAM) and read-only memory (ROM). The memory 408 may store computer-readable, computer-executable code including instructions that, when executed by the processor 406 cause the device 402 to perform various functions described herein. The code may be stored in a non-transitory computer-readable medium such as system memory or another type of memory. In some implementations, the code may not be directly executable by the processor 406 but may cause a computer (e.g., when compiled and executed) to perform functions described herein. In some implementations, the memory 408 may include, among other things, a basic I/O system (BIOS) which may control basic hardware or software operation such as the interaction with peripheral components or devices.

The I/O controller 414 may manage input and output signals for the device 402. The I/O controller 414 may also manage peripherals not integrated into the device 402. In some implementations, the I/O controller 414 may represent a physical connection or port to an external peripheral. In some implementations, the I/O controller 414 may utilize an operating system such as iOS®, ANDROID®, MS-DOS®, MS-WINDOWS®, OS/2®, UNIX®, LINUX®, or another known operating system. In some implementations, the I/O controller 414 may be implemented as part of a processor, such as the processor 406. In some implementations, a user may interact with the device 402 via the I/O controller 414 or via hardware components controlled by the I/O controller 414.

In some implementations, the device 402 may include a single antenna 416. However, in some other implementations, the device 402 may have more than one antenna 416, which may be capable of concurrently transmitting or receiving multiple wireless transmissions. The receiver 410 and the transmitter 412 may communicate bi-directionally, via the one or more antennas 416, wired, or wireless links as described herein. For example, the receiver 410 and the transmitter 412 may represent a wireless transceiver and may communicate bi-directionally with another wireless transceiver. The transceiver may also include a modem to modulate the packets, to provide the modulated packets to one or more antennas 416 for transmission, and to demodulate packets received from the one or more antennas 416.

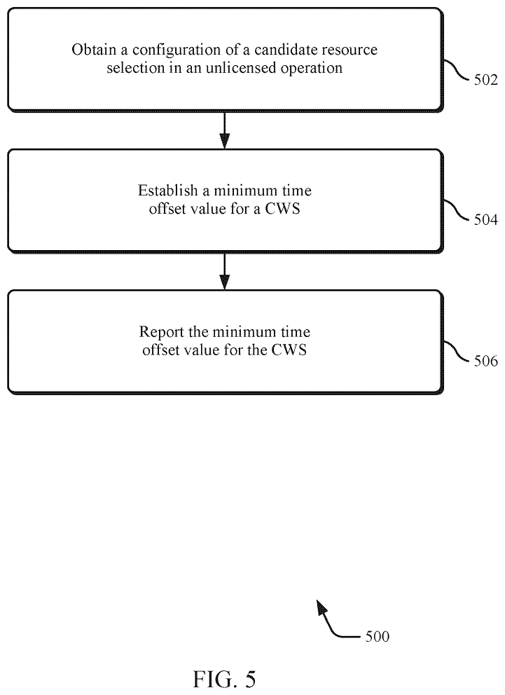

FIG. 5 illustrates a flowchart of a method 500 that supports CWS for unlicensed operation in accordance with aspects of the present disclosure. The operations of the method 500 may be implemented and performed by a device or its components, such as a UE 104 as described with reference to FIGS. 1 through 4. In some implementations, the device may execute a set of instructions to control the function elements of the device to perform the described functions. Additionally, or alternatively, the device may perform aspects of the described functions using special-purpose hardware.

At 502, the method may include obtaining a configuration of a candidate resource selection in an unlicensed operation. The operations of 502 may be performed in accordance with examples as described herein. In some implementations, aspects of the operations of 502 may be performed by a device as described with reference to FIG. 1.

At 504, the method may include establishing a minimum time offset value for a CWS. The operations of 504 may be performed in accordance with examples as described herein. In some implementations, aspects of the operations of 504 may be performed by a device as described with reference to FIG. 1.

At 506, the method may include reporting the minimum time offset value for the CWS. The operations of 506 may be performed in accordance with examples as described herein. In some implementations, aspects of the operations of 506 may be performed by a device as described with reference to FIG. 1.

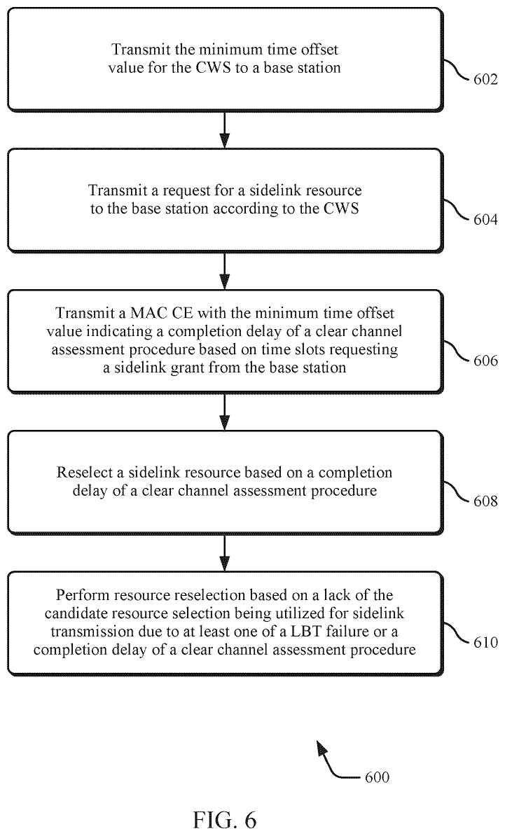

FIG. 6 illustrates a flowchart of a method 600 that supports CWS for unlicensed operation in accordance with aspects of the present disclosure. The operations of the method 600 may be implemented and performed by a device or its components, such as a UE 104 as described with reference to FIGS. 1 through 4. In some implementations, the device may execute a set of instructions to control the function elements of the device to perform the described functions. Additionally, or alternatively, the device may perform aspects of the described functions using special-purpose hardware.

At 602, the method may include transmitting the minimum time offset value for the CWS to a base station. The operations of 602 may be performed in accordance with examples as described herein. In some implementations, aspects of the operations of 602 may be performed by a device as described with reference to FIG. 1.

At 604, the method may include transmitting a request for a sidelink resource to the base station according to the CWS. The operations of 604 may be performed in accordance with examples as described herein. In some implementations, aspects of the operations of 604 may be performed by a device as described with reference to FIG. 1.

At 606, the method may include transmitting a MAC CE with the minimum time offset value indicating a completion delay of a clear channel assessment procedure based on time slots requesting a sidelink grant from the base station. The operations of 606 may be performed in accordance with examples as described herein. In some implementations, aspects of the operations of 606 may be performed by a device as described with reference to FIG. 1.

At 608, the method may include reselecting a sidelink resource based on a completion delay of a clear channel assessment procedure. The operations of 608 may be performed in accordance with examples as described herein. In some implementations, aspects of the operations of 608 may be performed by a device as described with reference to FIG. 1.

At 610, the method may include performing resource reselection based on a lack of the candidate resource selection being utilized for sidelink transmission due to at least one of a LBT failure or a completion delay of a clear channel assessment procedure. The operations of 610 may be performed in accordance with examples as described herein. In some implementations, aspects of the operations of 610 may be performed by a device as described with reference to FIG. 1.

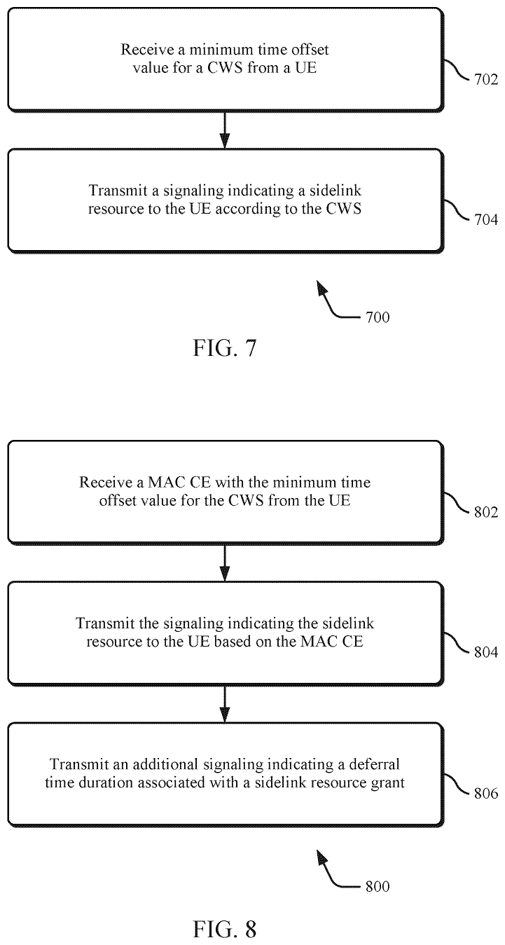

FIG. 7 illustrates a flowchart of a method 700 that supports CWS for unlicensed operation in accordance with aspects of the present disclosure. The operations of the method 700 may be implemented and performed by a device or its components, such as a base station 102 as described with reference to FIGS. 1 through 4. In some implementations, the device may execute a set of instructions to control the function elements of the device to perform the described functions. Additionally, or alternatively, the device may perform aspects of the described functions using special-purpose hardware.

At 702, the method may include receiving a minimum time offset value for a CWS from a UE. The operations of 702 may be performed in accordance with examples as described herein. In some implementations, aspects of the operations of 702 may be performed by a device as described with reference to FIG. 1.

At 704, the method may include transmitting a signaling indicating a sidelink resource to the UE according to the CWS. The operations of 704 may be performed in accordance with examples as described herein. In some implementations, aspects of the operations of 704 may be performed by a device as described with reference to FIG. 1.

FIG. 8 illustrates a flowchart of a method 800 that supports CWS for unlicensed operation in accordance with aspects of the present disclosure. The operations of the method 800 may be implemented and performed by a device or its components, such as a base station 102 as described with reference to FIGS. 1 through 4. In some implementations, the device may execute a set of instructions to control the function elements of the device to perform the described functions. Additionally, or alternatively, the device may perform aspects of the described functions using special-purpose hardware.

At 802, the method may include receiving a MAC CE with the minimum time offset value for the CWS from the UE. The operations of 802 may be performed in accordance with examples as described herein. In some implementations, aspects of the operations of 802 may be performed by a device as described with reference to FIG. 1.

At 804, the method may include transmitting the signaling indicating the sidelink resource to the UE based on the MAC CE. The operations of 804 may be performed in accordance with examples as described herein. In some implementations, aspects of the operations of 804 may be performed by a device as described with reference to FIG. 1.

At 806, the method may include transmitting an additional signaling indicating a deferral time duration associated with a sidelink resource grant. The operations of 806 may be performed in accordance with examples as described herein. In some implementations, aspects of the operations of 806 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined. The order in which the methods are described is not intended to be construed as a limitation, and any number or combination of the described method operations may be performed in any order to perform a method, or an alternate method.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C, or AB or AC or BC, or ABC (i.e., A and B and C). Similarly, a list of one or more of A, B, or C means A or B or C, or AB or AC or BC, or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the apparatus UE to:
obtain a configuration of a candidate resource selection in an unlicensed operation;
establish a minimum time offset value for a contention window size (CWS); and
report the minimum time offset value for the CWS.

2. The UE of claim 1, wherein the configuration of the candidate resource selection comprises at least one of a channel access priority class (CAPC) value, a maximum channel occupancy, a CWS update, or the minimum time offset value.

3. The UE of claim 1, wherein the at least one processor is configured to cause the UE to establish the minimum time offset value for the CWS based at least in part on an estimate of time to determine sidelink slots by a clear channel assessment procedure.

4. The UE of claim 1, wherein the at least one processor is configured to cause the UE to report the minimum time offset value for the CWS to at least one of a candidate resource selection procedure or a physical layer (PHY) of the UE for autonomous resource selection by the UE.

5. The UE of claim 1, wherein the at least one processor is configured to cause the UE to transmit the minimum time offset value for the CWS to a base station.

6. The UE of claim 5, wherein the at least one processor is configured to cause the UE to at least one of:
transmit a request for a sidelink resource to the base station according to the CWS; or
transmit a medium access control (MAC) control element (CE) with the minimum time offset value indicating a completion delay of a clear channel assessment procedure based on time slots requesting a sidelink grant from the base station.

7. The UE of claim 1, wherein the at least one processor is configured to cause the UE to reselect a sidelink resource based at least in part on a completion delay of a clear channel assessment procedure.

8. The UE of claim 7, wherein the completion delay of the clear channel assessment procedure is based on at least one of a lack of the candidate resource selection or a listen-before-talk (LBT) failure.

9. The UE of claim 1, wherein the at least one processor is configured to cause the UE to perform resource reselection based at least in part on a lack of the candidate resource selection being utilized for sidelink transmission due to at least one of a LBT failure or a completion delay of a clear channel assessment procedure.

10. A base station for wireless communication, comprising:
at least one memory; and
at least one processor coupled with the at least one memory and configured to cause the base station to:
receive, from a user equipment (UE), a minimum time offset value for a contention window size (CWS); and
transmit, to the UE, a signaling indicating a sidelink resource according to the CWS.

11. The base station of claim 10, wherein the at least one processor is configured to cause the base station to:
receive, from the UE, a medium access control (MAC) control element (CE) with the minimum time offset value for the CWS; and
transmit, to the UE, the signaling indicating the sidelink resource based at least in part on the MAC CE.

12. The base station of claim 10, wherein the at least one processor is configured to cause the base station to transmit an additional signaling indicating a deferral time duration associated with a sidelink resource grant.

13. The base station of claim 10, wherein the at least one processor is configured to cause the base station to transmit the signaling indicating the sidelink resource to the UE based at least in part on a highest CWS value corresponding to a channel access priority class.

14. A method performed by a user equipment (UE), the method comprising:
obtaining a configuration of a candidate resource selection in an unlicensed operation;
establishing a minimum time offset value for a contention window size (CWS); and
reporting the minimum time offset value for the CWS.

15-20. (canceled)

21. A processor for wireless communication, comprising:
at least one controller coupled with at least one memory and configured to cause the processor to:
obtain a configuration of a candidate resource selection in an unlicensed operation;
establish a minimum time offset value for a contention window size (CWS); and
report the minimum time offset value for the CWS.

22. The processor of claim 21, wherein the configuration of the candidate resource selection comprises at least one of a channel access priority class (CAPC) value, a maximum channel occupancy, a CWS update, or the minimum time offset value.

23. The processor of claim 21, wherein the at least one controller is configured to cause the processor to establish the minimum time offset value for the CWS based at least in part on an estimate of time to determine sidelink slots by a clear channel assessment procedure.

24. The processor of claim 21, wherein the at least one controller is configured to cause the processor to report the minimum time offset value for the CWS to at least one of a candidate resource selection procedure or a physical layer (PHY) of a user equipment (UE) for autonomous resource selection by the UE.

25. The processor of claim 21, wherein the at least one controller is configured to cause the processor to transmit the minimum time offset value for the CWS to a base station.

26. The processor of claim 21, wherein the at least one controller is configured to cause the processor to reselect a sidelink resource based at least in part on a completion delay of a clear channel assessment procedure.
